(19) United States
(12) Patent Application Publication
(10) Pub. No.: US 2024/0416928 A1
(43) Pub. Date: Dec. 19, 2024

(54) CONTROLLING CHARACTERISTICS OF A VEHICLE BASED AT LEAST IN PART ON A LOCATION OF THE VEHICLE

(71) Applicant: GM GLOBAL TECHNOLOGY OPERATIONS LLC, DETROIT, MI (US)

(72) Inventors: Byoungro Lee, Incheon (KR); Curtis L. Hay, Petoskey, MI (US)

(21) Appl. No.: 18/333,902

(22) Filed: Jun. 13, 2023

(51) Int. Cl. B60W 50/00; B60W 40/02

(52) U.S. Cl. CPC B60W 50/0098; B60W 40/02; B60W 2050/0083; B60W 2556/50

(57) ABSTRACT

Embodiments include controlling characteristics of a vehicle based at least in part on a location of the vehicle. Aspects include monitoring a location of a vehicle and one or more operational characteristics of the vehicle and based on determining that the vehicle has entered an at least partially enclosed area, automatically changing the one or more operational characteristics of the vehicle to a state associated with an enclosed space. Aspects also include automatically restoring the one or more operational characteristics of the vehicle to the state prior to the vehicle entering the at least partially enclosed area based on determining that the vehicle has exited the at least partially enclosed area.

### INTRODUCTION

The disclosure relates to a control system for a vehicle. More specifically, the disclosure relates to a system for controlling the characteristics of a vehicle based at least in part on the location of the vehicle.

Vehicles include a wide range of systems that are controlled by an operator of the vehicle. Such systems include, but are not limited to, the headlights of the vehicle, the windshield wipers of the vehicle, the heating and air conditioning (HVAC) systems of the vehicle, the windows of the vehicle, the sunroof or convertible top of the vehicle, and the like. Currently, the operators of a vehicle must manually and individually control the operations of each of these systems of the vehicle.

### SUMMARY

In one exemplary embodiment, a method for controlling characteristics of a vehicle based at least in part on a location of the vehicle is provided. The method includes monitoring a location of a vehicle and one or more operational characteristics of the vehicle and automatically changing the one or more operational characteristics of the vehicle to a state associated with an enclosed space based on determining that the vehicle has entered an at least partially enclosed area. The method also includes automatically restoring the one or more operational characteristics of the vehicle to the state prior to the vehicle entering the at least partially enclosed area based on determining that the vehicle has exited the at least partially enclosed area.

In addition to the one or more features described herein, the determination that the vehicle has entered into the least partially enclosed area is based at least in part on a geolocation signal received by the vehicle and based on a geolocation database that includes a location of known partially enclosed areas.

In addition to the one or more features described herein, the known partially enclosed areas include one or more tunnels and parking garages.

In addition to the one or more features described herein, the one or more operational characteristics of the vehicle include a position of a window of the vehicle, a position of a sunroof of the vehicle, an on/off state of an exterior light of the vehicle, an on/off state of an interior light of the vehicle, a brightness of the interior light of the vehicle, an on/off state of a windshield wiper of the vehicle, and a state of an air conditioning system of the vehicle.

In addition to the one or more features described herein, the state associated with the enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

In addition to the one or more features described herein, the method also includes automatically setting the one or more operational characteristics of the vehicle to a default state based on determining that the vehicle has exited the at least partially enclosed area and that the vehicle was in the at least partially enclosed area for longer than a threshold period of time.

In addition to the one or more features described herein, the method also includes automatically setting the one or more operational characteristics of the vehicle to a default state based on determining that the vehicle has exited the at least partially enclosed area and that the vehicle was turned off while in the at least partially enclosed area.

In addition to the one or more features described herein, the determination that the vehicle has exited the least partially enclosed area is based at least in part on a geolocation signal received by the vehicle and based on a geolocation database that includes a location of known partially enclosed areas.

In one exemplary embodiment, a vehicle is provided. The vehicle includes a geo-location sensor configured to receive a geo-location signal, a geo-location database that includes a location of each of a plurality of at least partially enclosed areas, and a controller. The controller is configured to monitor a location of the vehicle and one or more operational characteristics of the vehicle and based on determining that the vehicle has entered one of the plurality of at least partially enclosed areas, automatically change the one or more operational characteristics of the vehicle to a state associated with an enclosed space. The controller is also configured to automatically restore the one or more operational characteristics of the vehicle to the state prior to the vehicle entering the at least partially enclosed area based on determining that the vehicle has exited the one of the plurality of at least partially enclosed areas.

In addition to the one or more features described herein, the determination that the vehicle has entered into the one of the plurality of at least partially enclosed areas is based at least in part on the geolocation signal and the geolocation database.

In addition to the one or more features described herein, the plurality of at least partially enclosed areas include one or more tunnels and parking garages.

In addition to the one or more features described herein, the vehicle further includes a window, a sunroof, an exterior light, an interior light, a windshield wiper, and an air conditioning system.

In addition to the one or more features described herein, the one or more operational characteristics of the vehicle include a position of the window of the vehicle, a position of the sunroof of the vehicle, an on/off state of the exterior light of the vehicle, an on/off state of the interior light of the vehicle, a brightness of the interior light of the vehicle, an on/off state of the windshield wiper of the vehicle, and a state of the air conditioning system of the vehicle.

In addition to the one or more features described herein, the state associated with the enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

In addition to the one or more features described herein, the controller is further configured to automatically set the one or more operational characteristics of the vehicle to a default state based on determining that the vehicle has exited the at least partially enclosed area and that the vehicle was in the at least partially enclosed area for longer than a threshold period of time.

In addition to the one or more features described herein, the controller is further configured to automatically set the one or more operational characteristics of the vehicle to a default state based on determining that the vehicle has exited the at least partially enclosed area and that the vehicle was turned off while in the at least partially enclosed area.

In addition to the one or more features described herein, the determination that the vehicle has exited the one of the plurality of at least partially enclosed areas is based at least in part on the geolocation signal and the geolocation database.

In one exemplary embodiment, a vehicle is provided. The vehicle includes a window, a headlight, a geo-location sensor configured to receive a geo-location signal, a geo-location database that includes a location of each of a plurality of at least partially enclosed areas, and a controller. The controller is configured to monitor a location of the vehicle and an operational state of the headlight and a position of the window and based on determining that the vehicle has entered one of the plurality of at least partially enclosed areas, automatically close the window and turn on the headlight.

In addition to the one or more features described herein, the vehicle also includes a sunroof and the controller is further configured to automatically close the sunroof based on determining that the vehicle has entered the one of the plurality of at least partially enclosed areas.

In addition to the one or more features described herein, the plurality of at least partially enclosed areas include one or more tunnels and parking garages.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description.

FIG. 1 is a schematic diagram of a vehicle in accordance with an exemplary embodiment.

FIG. 2 is a block diagram illustrating a system for controlling the characteristics of a vehicle in accordance with an exemplary embodiment.

FIG. 3 is a flowchart diagram illustrating a method for controlling the characteristics of a vehicle based at least in part on a location of the vehicle in accordance with an exemplary embodiment.

FIG. 4 is a flowchart diagram illustrating another method for controlling the characteristics of a vehicle based at least in part on a location of the vehicle in accordance with an exemplary embodiment.

FIG. 5 is a flowchart diagram illustrating a further method for controlling the characteristics of a vehicle based at least in part on a location of the vehicle in accordance with an exemplary embodiment.

### DETAILED DESCRIPTION

The following description is merely exemplary in nature and is not intended to limit the present disclosure, its application, or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include systems and methods for controlling characteristics of a vehicle based at least in part on the location of the vehicle. In exemplary embodiments, the location of the vehicle is monitored, and it is determined when the enters or exits an at least partially enclosed area. The at least partially enclosed area is an area that is characterized by relatively low exposure to natural airflow. For example, the at least partially enclosed area may be a tunnel, an enclosed parking garage, or the like. Based on a determination that the vehicle has entered or exited an at least partially enclosed area, one or more operational characteristics of the vehicle are automatically adjusted. For example, when it is determined that a vehicle has entered a tunnel, the windows of the vehicle are automatically closed, the sunroof of the vehicle is automatically closed, the headlights of the vehicle are automatically turned on, the windshield wipers of the vehicle are set to the off position, and the HVAC system is set to recirculate the air in the cabin of the vehicle.

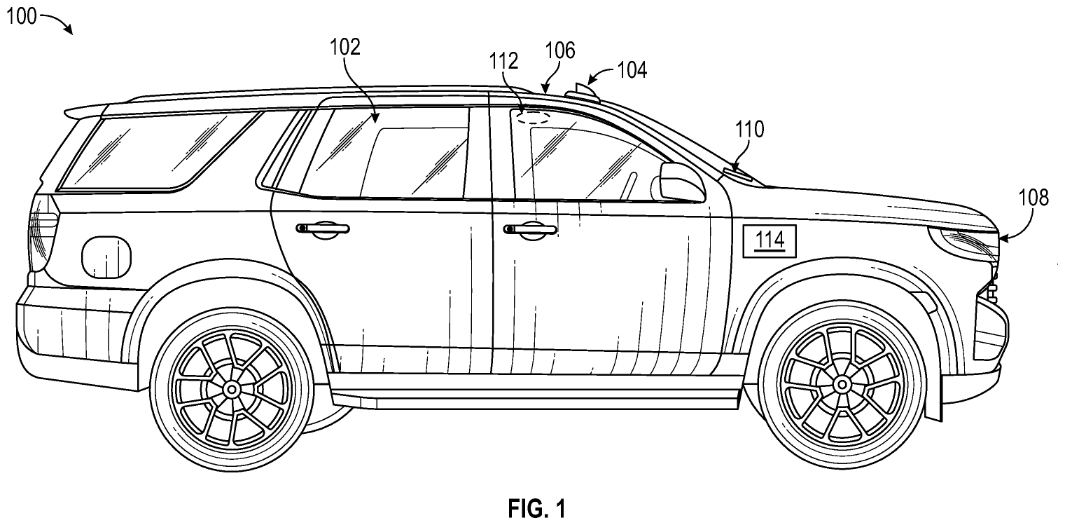

Referring now to FIG. 1, a schematic diagram of a vehicle 100 in accordance with an exemplary embodiment is shown. In exemplary embodiments, the vehicle 100 includes a one or more windows 102, a geo-location receiver 104, a sunroof 106, exterior lights 108, windshield wipers 110, one or more interior lights 112, and a heating and air conditioning system 114. In exemplary embodiments, the vehicle 100 also includes a controller (not shown) that is configured to determine a location of the vehicle based on geolocation signals received by the geo-location receiver 104. In exemplary embodiments, the controller is one of a general-purpose processor, a Field Programmable Gate Array (FPGA), an application-specific integrated circuit (ASIC), or the like. The controller is further configured to automatically adjust one or more of the windows 102, the sunroof 106, the exterior lights 108, the windshield wipers 110, the interior lights 112, and the heating and air conditioning system 114 based at least in part on the determined location of the vehicle 100.

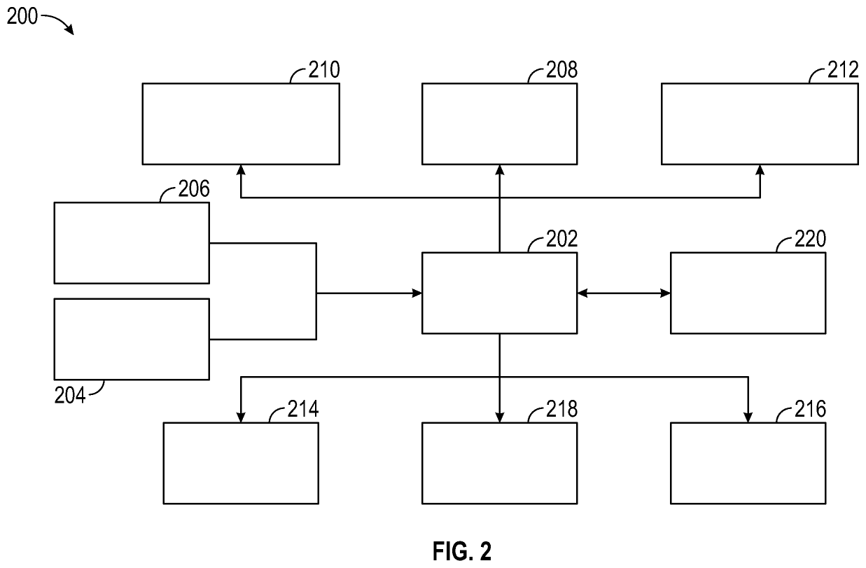

Referring now to FIG. 2 a block diagram illustrating a system 200 for controlling characteristics of a vehicle in accordance with an exemplary embodiment is shown. The system 200 includes a controller 202 that is one of a general-purpose processor, a Field Programmable Gate Array (FPGA), an application-specific integrated circuit (ASIC), or the like. The controller 202 is configured to receive data from a geo-location sensor 204, such as a global positioning system (GPS) sensor, that is used to determine a current location of the vehicle. The controller 202 is also configured to access a geo-location database 206 that includes known locations of various at least partially enclosed areas, such as enclosed parking garages, tunnels, and the like.

In exemplary embodiments, the controller 202 is configured to control one or more of a window actuator 208, a sunroof or convertible top actuator 210, a windshield wiper actuator 212, one or more interior lights 216 of the vehicle, one or more exterior lights 218 of the vehicle and a cabin HVAC system 214 of the vehicle. In exemplary embodiments, the system 200 includes a memory 220 that is configured to store operational characteristics of the window actuator 208, a sunroof or convertible top actuator 210, a windshield wiper actuator 212, one or more interior lights 216 of the vehicle, one or more exterior lights 218 of the vehicle and a cabin HVAC system 214 of the vehicle that are associated with the vehicle being in an enclosed space. In one embodiment, the operational characteristics associated with the vehicle being in an enclosed space are set by a manufacturer of the vehicle and can be modified by the operator of the vehicle.

In exemplary embodiments, the memory 220 is further configured to store one or more monitored operational characteristics of the vehicle and/or one or more monitored operational characteristics of the vehicle. For example, the controller 202 may monitor and store the operational characteristics of the vehicle in the memory 220 for later retrieval. In some embodiments, based on a determination that a vehicle is entering an at least partially enclosed area, the controller 202 is configured to obtain and store the current operational characteristics of the vehicle in the memory 220 and when it is determined that the vehicle is exiting at least partially enclosed area, the controller 202 is configured to restore the operational characteristics of the vehicle that were previously stored in the memory 220.

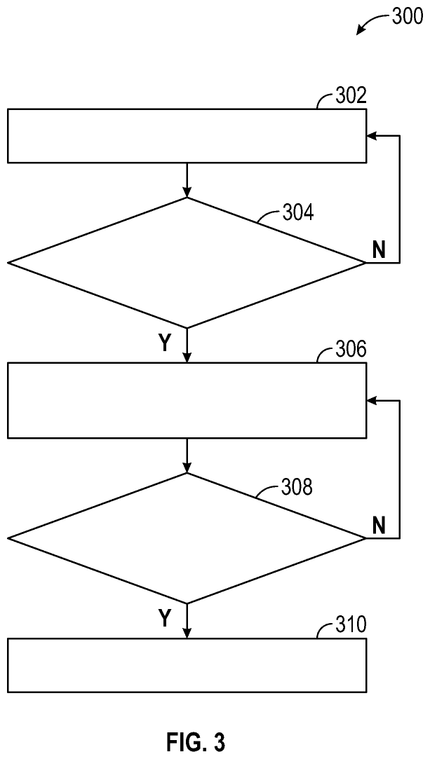

Referring now to FIG. 3, a flowchart diagram illustrating a method 300 for controlling characteristics of a vehicle based at least in part on a location of the vehicle in accordance with an exemplary embodiment is shown. At block 302, the method 300 includes monitoring a location of a vehicle and the operational characteristics of the vehicle. In exemplary embodiments, the location of the vehicle is obtained using a geolocation sensor of the vehicle. In exemplary embodiments, the one or more operational characteristics of the vehicle include a position of a window of the vehicle, a position of a sunroof of the vehicle, an on/off state of an exterior light of the vehicle, an on/off state of an interior light of the vehicle, a brightness of an interior light of a vehicle, an on/off state of a windshield wiper of the vehicle, and a state of an air conditioning system of the vehicle.

Next, at decision block 304, the method 300 includes determining whether the vehicle has entered an at least partially enclosed area. In exemplary embodiments, the determination that the vehicle has entered into the least partially enclosed area is based at least in part on a geolocation signal received by the vehicle and based on a geolocation database that includes a location of known partially enclosed areas. In one embodiment, the known partially enclosed areas include one or more tunnels and parking garages.

At block 306, the method 300 includes changing one or more of the operational characteristics of the vehicle to a state associated with the vehicle being in an enclosed space. In exemplary embodiments, the state associated with the vehicle being in an enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

Next, at decision block 308, the method 300 includes determining whether the vehicle has left the at least partially enclosed area. In exemplary embodiments, the determination that the vehicle has left the least partially enclosed area is based at least in part on a geolocation signal received by the vehicle and based on a geolocation database that includes a location of known partially enclosed areas. The method 300 concludes at block 310 by restoring the operation characteristics of the vehicle to its prior state, (i.e., the state before entering the at least partially enclosed area).

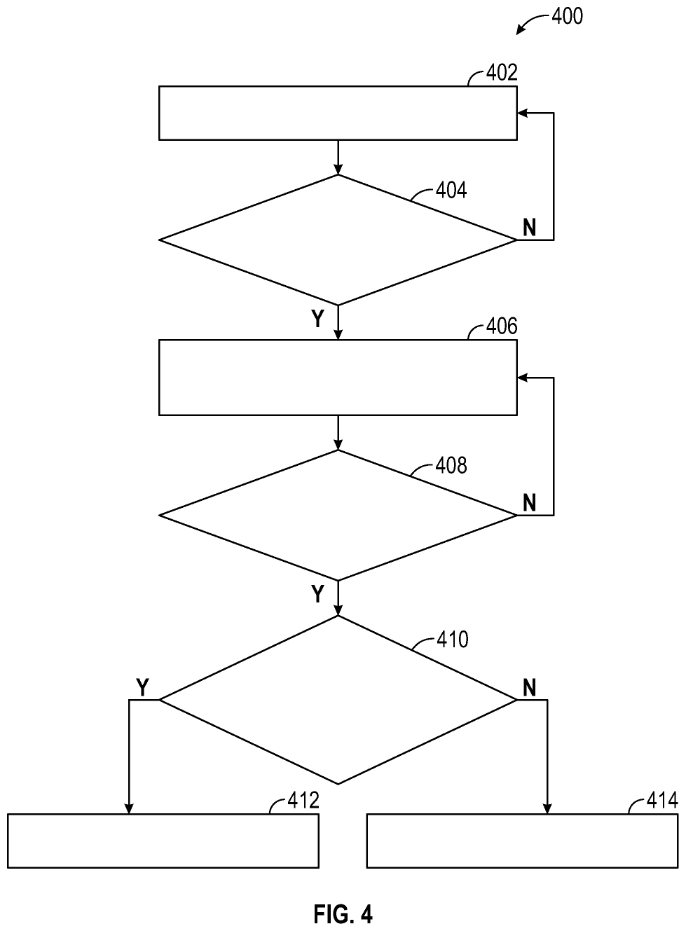

Referring now to FIG. 4, a flowchart diagram illustrating a method 400 for controlling characteristics of a vehicle based at least in part on a location of the vehicle in accordance with an exemplary embodiment is shown. At block 402, the method 400 includes monitoring a location of a vehicle and the operational characteristics of the vehicle. In exemplary embodiments, the location of the vehicle is obtained using a geolocation sensor of the vehicle. In exemplary embodiments, the one or more operational characteristics of the vehicle include a position of a window of the vehicle, a position of a sunroof of the vehicle, an on/off state of an exterior light of the vehicle, an on/off state of an interior light of the vehicle, a brightness of an interior light of a vehicle, an on/off state of a windshield wiper of the vehicle, and a state of an air conditioning system of the vehicle.

Next, at decision block 404, the method 400 includes determining whether the vehicle has entered an at least partially enclosed area. In exemplary embodiments, the determination that the vehicle has entered into the least partially enclosed area is based at least in part on a geolocation signal received by the vehicle and based on a geolocation database that includes a location of known partially enclosed areas. In one embodiment, the known partially enclosed areas include one or more tunnels and parking garages.

At block 406, the method 400 includes changing one or more of the operational characteristics of the vehicle to a state associated with the vehicle being in an enclosed space. In exemplary embodiments, the state associated with the vehicle being in an enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

Next, at decision block 408, the method 400 includes determining whether the vehicle has left the at least partially enclosed area. In exemplary embodiments, the determination that the vehicle has left the least partially enclosed area is based at least in part on a geolocation signal received by the vehicle and based on a geolocation database that includes a location of known partially enclosed areas. Based on a determination that the vehicle has left the at least partially enclosed area, the method 400 proceeds to decision block 410, and a determination is made whether the vehicle was inside the at least partially enclosed area for greater than a threshold period of time.

Based on a determination that the vehicle was inside the at least partially enclosed area for greater than a threshold period of time, the method 400 proceeds to block 412, and the operational characteristics of the vehicle are set to a default state. Based on a determination that the vehicle was not inside the at least partially enclosed area for greater than a threshold period of time, the method 400 proceeds to block 414, and the operational characteristics of the vehicle are set to their prior value, (i.e., the state before entering the at least partially enclosed area).

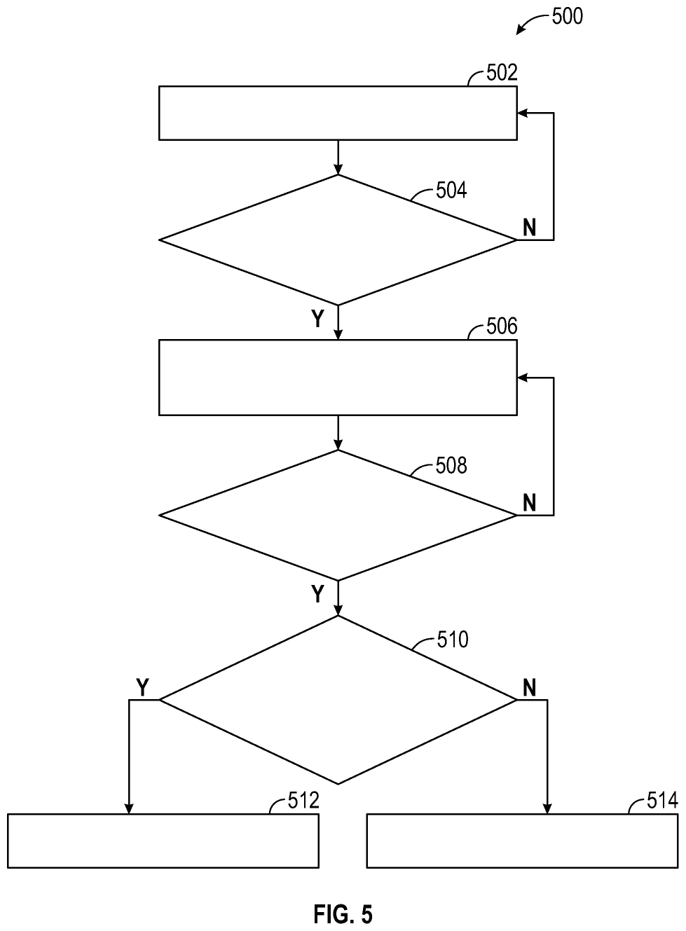

Referring now to FIG. 5, a flowchart diagram illustrating a method 500 for controlling characteristics of a vehicle based at least in part on a location of the vehicle in accordance with an exemplary embodiment is shown. At block 502, the method 500 includes monitoring a location of a vehicle and the operational characteristics of the vehicle. In exemplary embodiments, the location of the vehicle is obtained using a geolocation sensor of the vehicle. In exemplary embodiments, the one or more operational characteristics of the vehicle include a position of a window of the vehicle, a position of a sunroof of the vehicle, an on/off state of an exterior light of the vehicle, an on/off state of an interior light of the vehicle, a brightness of an interior light of a vehicle, an on/off state of a windshield wiper of the vehicle, and a state of an air conditioning system of the vehicle.

Next, at decision block 504, the method 500 includes determining whether the vehicle has entered an at least partially enclosed area. In exemplary embodiments, the determination that the vehicle has entered into the least partially enclosed area is based at least in part on a geolocation signal received by the vehicle and based on a geolocation database that includes a location of known partially enclosed areas. In one embodiment, the known partially enclosed areas include one or more tunnels and parking garages.

At block 506, the method 500 includes changing one or more of the operational characteristics of the vehicle to a state associated with the vehicle being in an enclosed space. In exemplary embodiments, the state associated with the vehicle being in an enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

Next, at decision block 508, the method 500 includes determining whether the vehicle has left the at least partially enclosed area. In exemplary embodiments, the determination that the vehicle has left the least partially enclosed area is based at least in part on a geolocation signal received by the vehicle and based on a geolocation database that includes a location of known partially enclosed areas. Based on a determination that the vehicle has left the at least partially enclosed area, the method 500 proceeds to decision block 510 and a determination is made whether the vehicle was turned off while inside the at least partially enclosed area.

Based on a determination that the vehicle was turned off while inside the at least partially enclosed area, the method 500 proceeds to block 512 and the operational characteristics of the vehicle are set to a default state. Based on a determination that the vehicle was not was turned off while inside the at least partially enclosed area, the method 500 proceeds to block 514 and the operational characteristics of the vehicle are set to their prior value, (i.e., the state before entering the at least partially enclosed area).

In exemplary embodiments, the operator of the vehicle may manually override the change in the operational characteristics of the vehicle that are made based on the vehicle entering and/or exiting an at least partially enclosed area. For example, when a vehicle enters an at least partially enclosed area, the windows of the vehicle are automatically closed, however, the operator of the vehicle is still able to manually control the position of the windows and open the windows if desired.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, (i.e., one, two, three, four, etc.). The terms “a plurality” may be understood to include any integer number greater than or equal to two, (i.e., two, three, four, five, etc.). The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for controlling characteristics of a vehicle based at least in part on a location of the vehicle, the method comprising:
monitoring the location of a vehicle and one or more operational characteristics of the vehicle;
based on determining that the vehicle has entered an at least partially enclosed area, automatically changing the one or more operational characteristics of the vehicle to a state associated with an enclosed space; and
based on determining that the vehicle has exited the at least partially enclosed area, automatically restoring the one or more operational characteristics of the vehicle to the state prior to the vehicle entering the at least partially enclosed area.

2. The method of claim 1, wherein the determination that the vehicle has entered into the least partially enclosed area is based at least in part on a geolocation signal received by the vehicle and based on a geolocation database that includes a location of known partially enclosed areas.

3. The method of claim 2, wherein the known partially enclosed areas include one or more tunnels and parking garages.

4. The method of claim 1, wherein the one or more operational characteristics of the vehicle include a position of a window of the vehicle, a position of a sunroof of the vehicle, an on/off state of an exterior light of the vehicle, an on/off state of an interior light of the vehicle, a brightness of the interior light of the vehicle, an on/off state of a windshield wiper of the vehicle, and a state of an air conditioning system of the vehicle.

5. The method of claim 4, wherein the state associated with the enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

6. The method of claim 1, further comprising:
based on determining that the vehicle has exited the at least partially enclosed area and that the vehicle was in the at least partially enclosed area for longer than a threshold period of time, automatically setting the one or more operational characteristics of the vehicle to a default state.

7. The method of claim 1, further comprising:
based on determining that the vehicle has exited the at least partially enclosed area and that the vehicle was turned off while in the at least partially enclosed area, automatically setting the one or more operational characteristics of the vehicle to a default state.

8. The method of claim 1, wherein the determination that the vehicle has exited the least partially enclosed area is based at least in part on a geolocation signal received by the vehicle and based on a geolocation database that includes a location of known partially enclosed areas.

9. A vehicle comprising,
a geo-location sensor configured to receive a geo-location signal;
a geo-location database that includes a location of each of a plurality of at least partially enclosed areas; and
a controller configured to:
monitor a location of the vehicle and one or more operational characteristics of the vehicle;
based on determining that the vehicle has entered one of the plurality of at least partially enclosed areas, automatically change the one or more operational characteristics of the vehicle to a state associated with an enclosed space; and
based on determining that the vehicle has exited the one of the plurality of at least partially enclosed areas, automatically restore the one or more operational characteristics of the vehicle to the state prior to the vehicle entering one of the plurality of at least partially enclosed areas.

10. The vehicle of claim 9, wherein the determination that the vehicle has entered into the one of the plurality of at least partially enclosed areas is based at least in part on a geolocation signal and a geolocation database.

11. The vehicle of claim 9, wherein the plurality of at least partially enclosed areas include one or more tunnels and parking garages.

12. The vehicle of claim 9, wherein the vehicle further includes a window, a sunroof, an exterior light, an interior light, a windshield wiper, and an air conditioning system.

13. The vehicle of claim 12, wherein the one or more operational characteristics of the vehicle include a position of the window of the vehicle, a position of the sunroof of the vehicle, an on/off state of the exterior light of the vehicle, an on/off state of the interior light of the vehicle, a brightness of the interior light of the vehicle, an on/off state of the windshield wiper of the vehicle, and a state of the air conditioning system of the vehicle.

14. The vehicle of claim 13, wherein the state associated with the enclosed space includes the window of the vehicle being in a closed position, the window of the vehicle being in a closed position, the sunroof of the vehicle being in a closed position, the exterior lights of the vehicle being in an on position, the windshield wiper of the vehicle being in an off position, and the air conditioning system of the vehicle being in an air re-circulation condition.

15. The vehicle of claim 9, wherein the controller is further configured to automatically set the one or more operational characteristics of the vehicle to a default state based on determining that the vehicle has exited the one of the plurality of at least partially enclosed areas and that the vehicle was in the one of the plurality of at least partially enclosed areas for longer than a threshold period of time.

16. The vehicle of claim 9, wherein the controller is further configured to automatically set the one or more operational characteristics of the vehicle to a default state based on determining that the vehicle has exited the one of the plurality of at least partially enclosed areas and that the vehicle was turned off while in the one of the plurality of at least partially enclosed areas.

17. The vehicle of claim 9, wherein the determination that the vehicle has exited the one of the plurality of at least partially enclosed areas is based at least in part on a geolocation signal and a geolocation database.

18. A vehicle comprising,
a window;
a headlight;
a geo-location sensor configured to receive a geo-location signal;
a geo-location database that includes a location of each of a plurality of at least partially enclosed areas; and
a controller configured to:
monitor a location of the vehicle and an operational state of the headlight and a position of the window; and
based on determining that the vehicle has entered one of the plurality of at least partially enclosed areas, automatically close the window and turn on the headlight.

19. The vehicle of claim 18, further comprising a sunroof and wherein the controller is further configured to automatically close the sunroof based on determining that the vehicle has entered the one of the plurality of at least partially enclosed areas.

20. The vehicle of claim 18, wherein the plurality of at least partially enclosed areas include one or more tunnels and parking garages.
